(19) United States
(12) Patent Application Publication
(10) Pub. No.: US 2026/0173147 A1
(43) Pub. Date: Jun. 18, 2026

(54) ENHANCED USER EQUIPMENT COLLABORATION AND RANDOM ACCESS CHANNEL ADAPTATION OPERATIONS

(71) Applicant: QUALCOMM Incorporated, San Diego, CA (US)

(72) Inventors: Navid Abedini, Basking Ridge, NJ (US); Meilong Jiang, Westfield, NJ (US); Jianghong Luo, Skillman, NJ (US); Tommy Azzino, Jersey City, NJ (US)

(21) Appl. No.: 18/981,102

(22) Filed: Dec. 13, 2024

(51) Int. Cl. H04W 74/0833; H04W 8/22; H04W 92/18

(52) U.S. Cl. CPC H04W 74/0833; H04W 8/22; H04W 92/18

(57) ABSTRACT

This disclosure provides systems, methods, and devices for wireless communication that support enhanced sidelink reporting operations. In a first aspect, a device for wireless communication includes at least one processor and a memory coupled to the at least one processor. The at least one processor is configured to cause the device to: receive UE assistance information from a user equipment (UE); transmit, to a network entity, a request for UE assistance based on the received UE assistance information from the UE; receive UE assistance response information from the network entity responsive to transmission of the request for UE assistance; and transmit at least a portion of the UE assistance response information to the UE. Other aspects and features are also claimed and described.

### TECHNICAL FIELD

Aspects of the present disclosure relate generally to wireless communication systems, and more particularly, to enhanced UE collaboration operations. Some features may enable and provide improved communications and network functionality, including improved network energy saving operations and random access channel (RACH) operations from the enhanced UE collaboration operations to provide the network with information about non-connected devices.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grow with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes: receiving UE assistance information from a user equipment (UE); transmitting, to a network entity, a request for UE assistance based on the received UE assistance information from the UE; receiving UE assistance response information from the network entity responsive to transmission of the request for UE assistance; and transmitting at least a portion of the UE assistance response information to the UE.

In an additional aspect of the disclosure, an apparatus configured for wireless communication is disclosed. The apparatus includes at least one processor, and a memory coupled to the at least one processor. The at least one processor is configured to cause the device to: receive UE assistance information from a user equipment (UE); transmit, to a network entity, a request for UE assistance based on the received UE assistance information from the UE; receive UE assistance response information from the network entity responsive to transmission of the request for UE assistance; and transmit at least a portion of the UE assistance response information to the UE.

In an additional aspect of the disclosure, an apparatus configured for wireless communication is disclosed. The apparatus includes: means for receiving UE assistance information from a user equipment (UE); means for transmitting, to a network entity, a request for UE assistance based on the received UE assistance information from the UE; means for receiving UE assistance response information from the network entity responsive to transmission of the request for UE assistance; and means for transmitting at least a portion of the UE assistance response information to the UE.

In an additional aspect of the disclosure, a non-transitory computer-readable medium stores instructions that, when executed by a processor, cause the processor to perform operations including: receiving UE assistance information from a user equipment (UE); transmitting, to a network entity, a request for UE assistance based on the received UE assistance information from the UE; receiving UE assistance response information from the network entity responsive to transmission of the request for UE assistance; and transmitting at least a portion of the UE assistance response information to the UE.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating example details of an example wireless communication system according to one or more aspects.

FIG. 2 is a block diagram illustrating examples of a base station and a user equipment (UE) according to one or more aspects.

FIG. 3 is a diagram of an example of connection establishment operations for a remote UE connecting to a network through a relay UE.

FIG. 4 is a block diagram illustrating an example wireless communication system that supports enhanced UE collaboration operations according to one or more aspects.

FIG. 5 is a timing diagram illustrating an example process that supports enhanced UE collaboration operations according to one or more aspects.

FIG. 6 is a timing diagram illustrating an example process that supports enhanced UE collaboration operations according to one or more aspects.

FIG. 7 is a timing diagram illustrating an example process that supports enhanced UE collaboration operations according to one or more aspects.

FIG. 8 is a flow diagram illustrating an example process that supports enhanced UE collaboration operations according to one or more aspects.

FIG. 9 is a flow diagram illustrating an example process that supports enhanced UE collaboration operations according to one or more aspects.

FIG. 10 is a block diagram of an example UE that supports enhanced UE collaboration operations according to one or more aspects.

FIG. 11 is a block diagram of an example base station that supports enhanced UE collaboration operations according to one or more aspects.

Like reference numbers and designations in the various drawings indicate like elements.

### DETAILED DESCRIPTION

The detailed description set forth below, in connection with the appended, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), CDMA2000, and the like. UTRA includes wideband-CDMA (W-CDMA) and low chip rate (LCR). CDMA2000 covers IS-2000, IS-95, and IS-856 standards.

A TDMA network may, for example, implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS, LTE, and NR are described in documents provided from an organization named “3rd Generation Partnership Project” (3GPP), and CDMA2000 is described in documents from an organization named “3rd Generation Partnership Project 2” (3GPP 2 ). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “mmWave” or the like, if used herein, may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus, and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements, etc. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, aggregated or dis-aggregated deployments, end-user devices, etc. of varying sizes, shapes, and constitution.

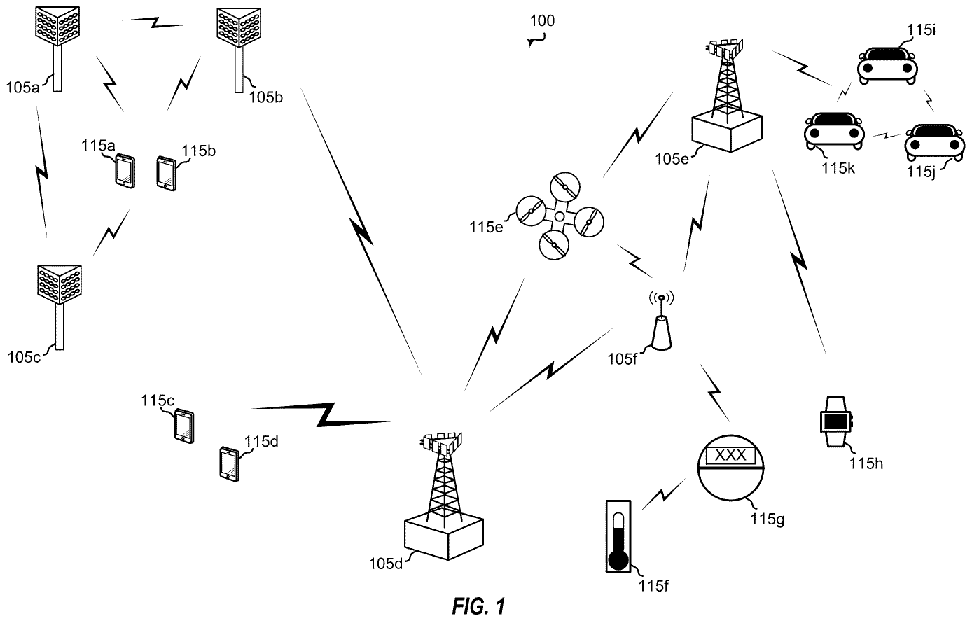

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with one or more UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station, which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water meter, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc. ; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

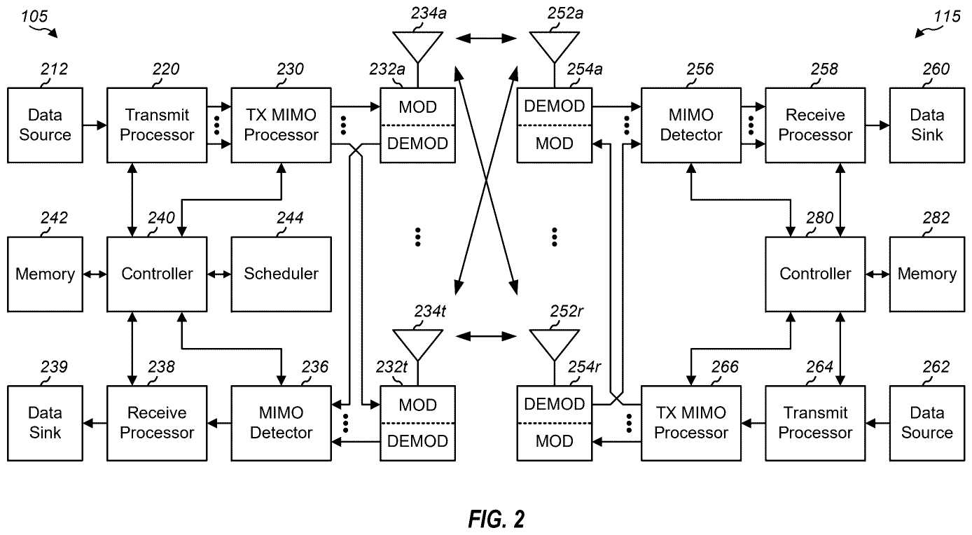

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

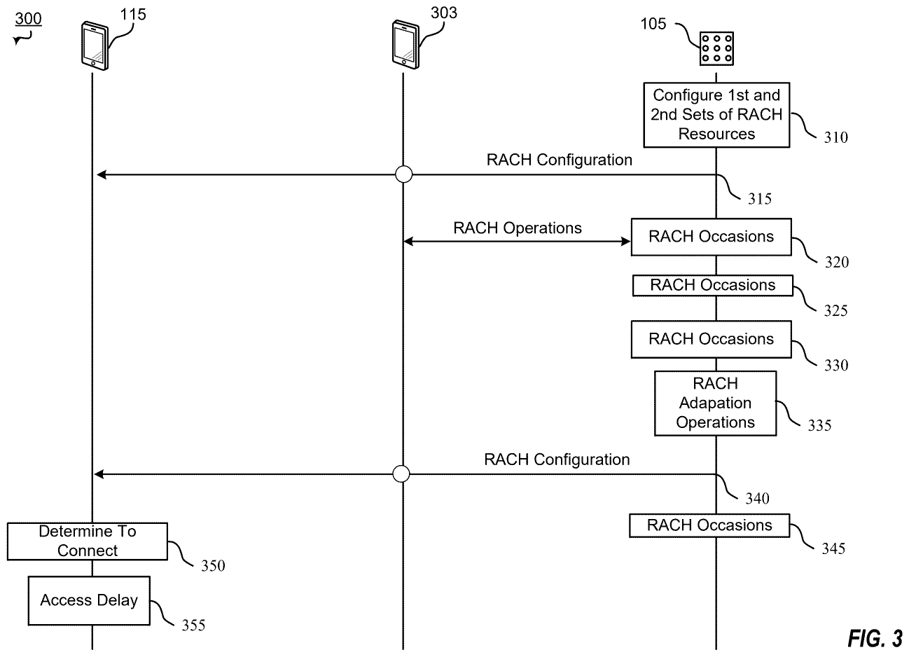

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 3-11, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Random access channel (RACH) operations are used by the network to provide basic service information and to enable connection establishment operations, handover operations, and failure recovery operations. RACH operations may consume a large amount of energy and processing power at network entities, such as base stations and other network devices of distributed or open network architectures. In order to reduce power and processing consumption, it has been proposed to perform network energy saving (NES) operations to reduce resource consumption at network entities under certain conditions. One such example of an NES operation or improvement is RACH adaptation as a NES scheme.

For example, a NES network entity (e.g., NES cell or base station) may have or configure multiple sets of RACH resources, such as through system or higher level messages (e.g., SIB and/or RRC). The multiple sets of RACH resources (e.g., occasions, preambles, beams, etc.) may have different resource configurations that enable the NES network entity to conserve resources when one or more of the sets of RACH resources are activated or deactivated. That is, the NES network entity can switch or activate multiple sets to increase RACH resources or switch and/or deactivate a set or sets of RACH resources to reduce RACH resources and conserve power.

In one particular illustration, a NES network entity has a first set of RACH resources that can be used by all UEs (e.g., legacy UEs, RedCap UEs, current generation UEs, etc.) and may have a second set of RACH resources that can be used by only certain types of UEs (e.g., next-generation and/or NES capable UEs). The second set of RACH resources may have many more RACH resources (e.g., more occasions, more frequent repetitions, etc.) than the first set of RACH resources in some examples. However, the NES network entity may deactivate the second set of RACH resources (e.g., perform RACH adaptation) frequently to reduce resource consumption and save power, and to operate in the NES mode. Additionally, the first set of RACH resources may be configured to provide very infrequent RACH resources (e.g., occasions), and this may leave unconnected UEs or certain types of UEs with very infrequent RACH resources and cause higher access latency and higher failure recovery latency.

In the proposed NES schemes, the network is assigned with determining how and when to perform RACH adaptation. That is, when to switch between configured sets of RACH resources and which sets of RACH resources to activate or how to change RACH configurations. The scheme for the network making decisions regarding RACH adaptation is an open item. However, currently the network does not have a method of visibility into the presence and population of idle/inactive UEs (at the cell-level). For example, the network does not have information regarding the amount of idle or inactive UEs for a particular cell. Thus, the network does not have information on how many UEs (or their types) may attempt to perform RACH operations to connect to the network in the near future. Accordingly, because the default configured first set of RACH resources may be designed to be very infrequent to conserve power, and because the network may not have good information of when to perform RACH adaptation, the NES schemes may have a negative impact on UE performance (e.g., higher access latency), especially for certain types of devices (e.g., legacy, RedCap, IoT, etc.).

In the aspects described herein, systems and methods are disclosed to use cooperative UE communication schemes to provide the network with information that can be used to implement RACH adaptation and other NES schemes with reduced negative impacts and, in some cases, improve both NES and UE performance. In some aspects, device-to-device communication is used by a connected UE to obtain information from such idle/inactive UEs, and the connected UE can then provide or relay this information to the network. For example, UE collaboration operations can be used to provide information (e.g., assisted UE information) from an idle or inactive UE regarding NES and/or RACH adaptation operations to the network via a connected UE.

In some such aspects, UE collaboration operations are performed to provide non-connected or remote UE information to the network so that the network can perform NES adaptation operations and/or RACH adaptation operations based on the information of one or more idle or inactive UEs.

FIG. 3 illustrates an example of NES RACH adaptation operations and corresponding connection establishment operations. In FIG. 3, connection establishment operations are shown for two UEs establishing connections with a network device operating in an NES mode with RACH adaptation. FIG. 3 illustrates a timing diagram of connection establishment operations for a UE 115 (e.g., a first UE), a second UE 303 (e.g., a second UE), and a base station 105. The devices may engage in half and/or full-duplex operations. Full-duplex operations correspond to transmitting and/or receiving data via multiple antennas at the same time. Half-duplex operations correspond to transmitting or receiving data via a single antenna at a particular time. UEs and network devices, such as UE 115, the second UE 303, and the base station 105, may establish uplink/downlink communication links (e.g., a Uu communication link), the UE 115 and the second UE 303 may each communicate with the base station 105 over the Uu communication link by transmitting and/or receiving transmissions.

During operation, at 310, the base station 105 may configure multiple sets of RACH resources. For example, the base station 105 may be an NES capable network entity and may not be operating in an NES mode, and the base station 105 may configure and/or activate a first set of RACH resources (e.g., legacy RACH resources or NES RACH resources) and a second set of RACH resources (e.g., non-NES RACH resources or RACH adaptation resources). The sets of RACH resources may include or correspond to preconfigured or standard specified RACH resources in some aspects. The RACH resource configurations may be advertised via system information block (SIB) messages, higher layer messages (e.g., RRC), or both.

At 315, the base station 105 advertises the multiple sets of RACH resources. For example, the base station 105 may transmit a SIB1 message (or other MIB or SIB message) including first RACH resource set information and second RACH resource set information. The base station 105 may also include activation indicators to indicate that both such configurations or RACH resource sets indicated by or included in the SIB1 message are activated. In some aspects, the base station 105 may also advertise additional RACH resource sets and/or other NES configuration settings.

From 320-330, the network may provide multiple RACH occasions for connection establishment operations by virtue of configuring or activating the first and second RACH resources sets. The RACH occasions may correspond to the multiple RACH configurations or sets of RACH resources configured. As an illustrative example, first and third RACH occasions may correspond to the second RACH configuration or set of RACH resources and the second RACH occasions may correspond to the first RACH configuration or set of resources. As illustrated in FIG. 3, the RACH occasions for the first set of RACH resources may include less occasions and longer times between occasions, as compared to the RACH occasions of the second set of RACH resources to conserver power, but also leading to higher access latency for devices when the second set of RACH resources are not configured, as illustrated and explained further after RACH adaptation at 335.

The RACH occasions may enable UEs to connect or reconnect to the network, perform handovers, or resolve failures, that is to or with the base station 105. For example, the second UE 303 and the base station may perform RACH operations to perform connection establishment. To illustrate, during one of the configured RACH occasions, the second UE 303 transmits a connection establishment request to the base station 105. For example, the second UE 303 may transmit a higher layer message or transmission requesting to perform connection establishment operations responsive to and based on the discovery operations performed (e.g., receipt of system information). The base station 105 transmits a connection establishment message to the second UE 303 responsive to the connection establishment request message. The base station 105 and the second UE 303 may perform 2 or 4-step RACH operations using contention-free or contention-based RACH resources.

At 335, the network determines to perform NES operations, such as or including RACH adaptation operations. For example, the network (e.g., the base station 105 or a specific entity or function) may determine to switch to an NES mode or perform RACH adaptation based on network or specific cell performance (e.g., power and/or CPU consumption) or network or specific cell activity (e.g., utilization or amount of connected UEs). However, the network's NES determination does not account for the amount of idle or unconnected UEs for RACH adaptation and does not account for other UE related or known information for other NES operations.

Response to the determination to perform NES operations (e.g., switch to NES mode) or perform RACH adaptation, the base station 105 may adjust the RACH configuration. For example, the base station 105 may deactivate one or more sets of RACH resources and/or switch which set or set of RACH resources are configured. In the example of FIG. 3, the base station 105 determines to deactivate the second set of RACH resources (e.g., the set of RACH resources with more occasions or requiring higher resources).

At 340, the base station 105 advertises the change to the configured RACH resources. For example, the base station 105 may transmit or broadcast a RRC or a SIB message including an indicator for NES operations and/or RACH adaptation operations. As another example, the base station 105 may transmit or broadcast a RRC or SIB message that includes only the first set of RACH resources or that includes the second set of RACH resources but also includes a deactivation indicator or an inactive indicator for the second set of RACH resources.

At 345, the network may provide multiple RACH occasions for connection establishment operations. The RACH occasions may correspond to the RACH configuration(s) or set(s) of RACH resources configured. As an illustrative example, fourth RACH occasions are provided at 345 and correspond to the first RACH configuration or set of resources. As illustrated in FIG. 3, the fourth RACH occasions for the first set of RACH resources may include less occasions and longer times between occasions to conserver power, but also leading to higher access latency for devices when the second set of RACH resources are not configured.

At 350, the UE 115 determines to connect to the network, such as the base station 105 thereof. For example, the UE 115 determines it has data to send, has been paged, etc., and attempts to connect to the base station 105 using RACH operations. However, in the example of FIG. 3, the configured RACH occasions of the base station 105 have passed and because the base station 105 is operating in the NES mode with less RACH resources configured (e.g., less RACH occasions), the UE 115 may experience an access delay at 355 until a next configured RACH occasion occurs that it can use. This delay may lead increased access latency or failure resolution latency, and may reduce UE performance and user experience. In the aspects described herein, a UE, such as the UE 115, may establish or leverage a connection with another UE, such as the second UE 303, to provide UE related information to the network and enable the network to have information regarding idle and inactive UEs to perform NES and/or RACH adaptation operations, leading to improved NES and RACH adaptation performance.

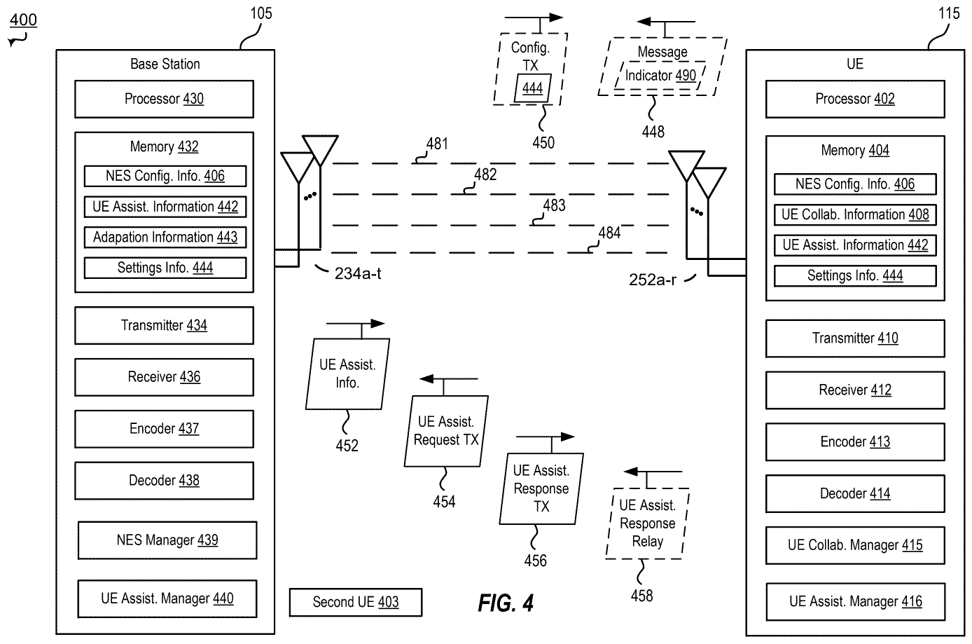

FIG. 4 illustrates an example of a wireless communications system 400 that supports enhanced UE collaboration operations in accordance with aspects of the present disclosure. In some examples, wireless communications system 400 may implement aspects of wireless communication system 100. For example, wireless communications system 400 may include a network, such as one or more network entities, and one or more UEs, such as UE 115 (also referred to as a first UE and optionally operating as an assisting UE or relay UE at times) and second UE 403 (optionally operating as an assisted UE or remote UE at times). As illustrated in the example of FIG. 4, the network entity includes and corresponds to a base station, such as base station 105. Alternatively, the network entity may include or correspond to a different network device (e.g., not a base station). Enhanced UE collaboration operations may improve UE functionality and performance and reduce the negative impacts associated with network energy savings operations, including RACH adaptation operations. These improvements may reduce access and recovery latency and offer improved RACH adaptations for NES operations and may also enable improvements to other NES operations and provide additional information to the network about idle and inactive UEs to enable the network to make more informed decisions and changes to network configurations. Accordingly, network and device performance can be increased.

Base station 105, UE 115, and second UE 403 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “mmWave” or the like, if used herein, may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, or a Bandwidth Part (BWP) ID. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as beam management or BWP switching functionality. In some implementations, two or more CCs are quasi co-located, such that the CCs have the same beam and/or same symbol.

In some implementations, control information may be communicated via base station 105, UE 115, and second UE 403. For example, the control information may be communicated suing MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can include processor 402, memory 404, transmitter 410, receiver 412, encoder, 413, decoder 414, UE collaboration manager 415, UE assistance manager 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store NES configuration information 406, UE collaboration information 408, UE assistance information 442, settings information 444, or a combination thereof, as further described herein.

The NES configuration information 406 includes or corresponds to data associated with or corresponding to NES operations, and may be referred to as NES operations configuration or settings information. For example, the NES configuration information 406 may include settings or configuration information for engaging with network entities in NES mode or with NES capabilities, different NES configurations for NES and non-NES modes, NES reporting information configurations, NES adaptation configurations or capabilities, or a combination thereof. The NES configuration information 406 may be stored in one or more information elements (IEs), such as NES specific IEs (e.g., NES IEs, NES reporting IEs, NES adaptation IEs, etc.) and/or procedure specific IEs (e.g., RACH IEs, RLF IEs, beam failure IEs, etc.). When procedure specific IEs are used, the network may configure legacy and NES version of such variables, such as RACH IEs and NES RACH IEs. Additionally, or alternatively, the NES configuration information 406 may include configuration information for performing UE collaboration operations and/or reporting or relaying UE assistance information and/or generating and transmitting UE assistance requests for adaptations of NES operations.

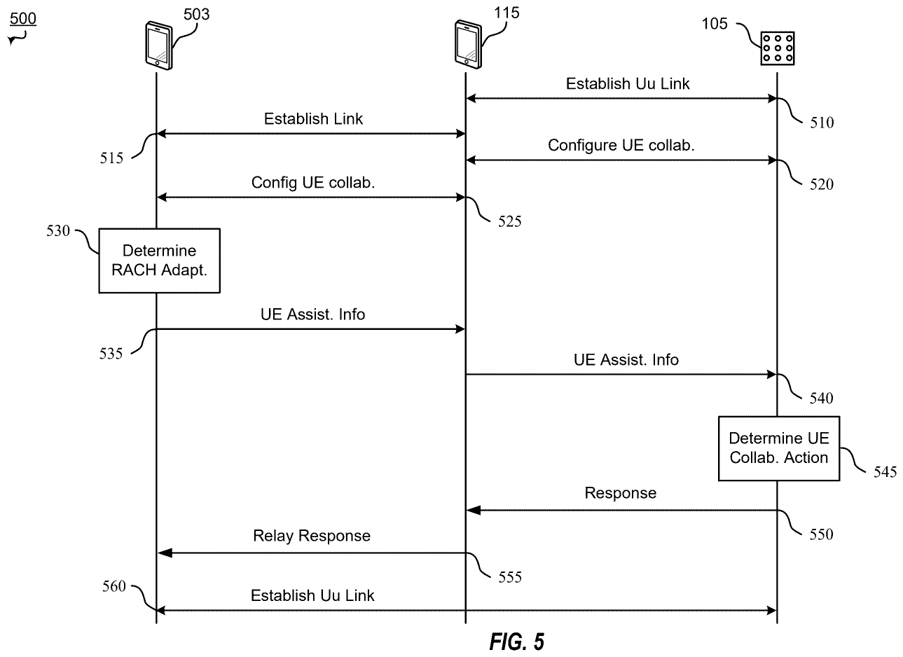

The UE collaboration information 408 includes or corresponds to data associated with or corresponding to performing UE collaboration operations. For example, the UE collaboration information 408 may include data and/or configuration information for establishing device-to-device connections for relaying information and/or requests from non-connected UEs to the network. In some aspects, the UE collaboration information 408 may include assisting UE information, assisted UE information, or both. For example, the UE collaboration information 408 may include information about the assisting or relay UE that is providing the link to the network for the non-connected UEs. Additionally, or alternatively, the UE collaboration information 408 may include information about the assisted or remote UE that is providing information and/or requests for NES and/or RACH adaptation operations. Detailed examples of the types of information of the UE collaboration information 408 are further described with reference to FIGS. 5-7.

The UE assistance information 442 includes or corresponds to data associated with or corresponding to performing UE assistance operations. For example, the UE assistance information 442 may include data and/or configuration information for reporting requests from and information about non-connected or remote UEs. For example, the UE assistance information 442 may include information about the assisted or remote UE that is providing information and/or requests for NES and/or RACH adaptation operations. To illustrate, the UE assistance information 442 may include a portion of the UE collaboration information, such as the assisted UE information indicating information about the non-connected UE. The UE assistance information 442, such as the information about the non-connected UE, may enable the network (e.g., the base station 105) to grant or deny the request from the non-connected UE. Additionally, or alternatively, the UE assistance information 442 may include a portion of the UE collaboration information 408 about the assisting or relay UE that is providing the link to the network for the non-connected UEs. For example, the UE assistance information 442 may include assisting UE information about the connected UE to enable the network to determine if the UE should be assisting, to grant or deny an adaptation/assistance request, or how to adapt or remediate the network settings or NES mode to grant the adoption/assistance request.

As another example, the UE assistance information 442 may indicate, in addition to or in the alternative of the information about the collaborating UEs, a particular type of request (e.g., NES adaptation, RACH adaptation, beam adaptation, power level adaptation, etc.) and/or a particular type of requested adaptation action (e.g., stop or suspend a certain type of NES mode, activate RACH resources, change RACH resources, activate additional beams, change beam configurations, etc.). For example, the UE assistance information 442 may include UE assistance request information indicating a UE request from a remote or assisted UE that is not connected (e.g., the second UE 403) and may include UE assistance request adoption information indicating a particular adaptation or remediation action. Detailed examples of the types of information of the UE assistance information 442 are further described with reference to FIGS. 5-7.

The settings information 444 includes or corresponds to data associated with enhanced UE collaboration operations. The settings information 444 may include one or more types of enhanced UE collaboration operation modes and/or thresholds or conditions for switching between enhanced sidelink UE collaboration modes and/or configurations thereof. For example, the settings information 444 may have data indicating different thresholds and/or conditions for different enhanced UE collaboration modes, such as which pieces of UE assistance information to send, in what report to send the UE assistance information, push UE assistance information reporting, pull UE assistance information reporting, etc., or a combination thereof.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410 or receiver 412 may include or correspond to one or more components of UE 115 described with reference to FIG. 2.

Encoder 413 and decoder 414 may be configured to encode and decode data for transmission. UE collaboration manager 415 may be configured to perform UE collaboration operations. For example, UE collaboration manager 415 may be configured to determine UE collaboration information 408 for reporting, such as which information to report and what not to report. To illustrate, the UE collaboration manager 415 may be configured to determine which pieces of UE collaboration information 408 to generate and/or which pieces of UE collaboration information 408 to transmit. Optionally, the UE collaboration manager 415 may be configured to determine with which devices to collaborate, such as if one or more collaboration conditions are satisfied. As an example, the UE collaboration manager 415 may determine that the UE collaboration information 408 or the UE assistance information 442 satisfy UE collaboration conditions. Additionally, or alternatively, the UE collaboration manager 415 may be configured to generate and transmit UE collaboration operation transmissions, engage in discovery and connection establishment for UE collaboration, or a combination thereof.

UE assistance manager 416 may be configured to perform UE assistance operations, such as UE assistance information determination and/or generation operations, UE request generation and transmission operations, UE assistance response relay operations, etc. For example, UE assistance manager 416 may be configured to generate the UE assistance information 442 based on the assisting and assisted UE information of the UE collaboration information 408. As another example, the UE assistance manager 416 may be configured to generate a UE assistance transmission or reporting including the UE assistance information 442. For example, the UE assistance manager 416 may be configured to include certain pieces of assisted and/or assisting UE information in the transmission along with a request indication for UE assistance. The request indication for UE assistance may indicate a type of assistance (e.g., RACH adaptation assistance) requested along with the specific adaptation requested for the assistance request (e.g., activate RACH resource).

Second UE 403 may include one or more elements similar to UE 115. In some implementations, the second UE 403 is not connected to (e.g., RRC inactive or idle) or is out of coverage for the base station 105, and the second UE 403 may optionally be connected to the UE 115 (and to the base station 105 via the UE 115). In other implementations, the second UE 403 is in coverage for the base station 105. In some such implementations, the second UE 403 may act as a relay UE for the UE 115.

In some implementations, the UE 115 and the second UE 403 are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc.

Base station 105 includes processor 430, memory 432, transmitter 434, receiver 436, encoder 437, decoder 438, NES manager 439, UE assistance manager 440, and antennas 234a-t. Processor 430 may be configured to execute instructions stored at memory 432 to perform the operations described herein. In some implementations, processor 430 includes or corresponds to controller/processor 240, and memory 432 includes or corresponds to memory 242. Memory 432 may be configured to store NES configuration information 406, UE assistance information 442, adaptation information 443, settings information 444, settings data, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434 or receiver 436 may include or correspond to one or more components of UE 115 described with reference to FIG. 2.

Encoder 437 and decoder 438 may include the same functionality as described with reference to encoder 413 and decoder 414, respectively. NES manager 439 may be configured to determine NES operations and to provide NES configurations to devices of the network. The NES manager 439 may be configured to engage in NES operations, activate, deactivate, and/or switch NES configurations, adjust/change NES operations, switch NES modes, etc.

UE assistance manager 440 may include similar functionality as described with reference to UE assistance manager 416. Additionally, the UE assistance manager 440 may be configured to determine adaptation or remediation operations and perform the adaptation or remediation operations in response to UE assistance requests from connected devices for non-connected devices. To illustrate, the UE assistance manager 440 may determine a changed configuration or an action for a base station device or a UE to perform RACH operations, recover from a beam failure, recover from a radio link failure (RLF), recover from a connection failure, recover from a handover failure, etc. As another example, the UE assistance manager 440 may be configured to provide the adaptation or remediation determination to one or more other devices. In some aspects, the base station 105 may further include a UE collaboration manager similar to the UE collaboration manager 415.

During operation of wireless communications system 400, the network (e.g., base station 105) may determine that UE 115 has enhanced UE collaboration operations capability. For example, UE 115 may transmit a message 448 that includes an enhanced UE collaboration operation indicator 490 (e.g., UE collaboration capability indicator and/or UE assistance capability indicator). Indicator 490 may indicate enhanced UE collaboration operations capability for one or more communication modes, such as downlink, uplink, sidelink, relay link, etc., or for a particular type of assistance, such as single device assistance, group assistance, legacy UE assistance, RedCap UE assistance, etc. In some implementations, a network entity (e.g., a base station 105) sends control information to indicate to UEs (e.g., UE 115 and/or second UE 403) that enhanced UE collaboration operations and/or a particular type of enhanced UE collaboration operation is to be used. For example, in some implementations, configuration transmission 450 is transmitted to the UE 115. The configuration transmission 450 may include or indicate to use enhanced UE collaboration operations or to adjust or implement a setting of a particular type of enhanced UE collaboration operation. For example, the configuration transmission 450 may include settings information 444, as indicated in the example of FIG. 4, NES configuration information 406, UE collaboration information 408 (e.g., UE collaboration configuration information), or a combination thereof.

During operation, devices of wireless communications system 400 perform enhanced UE collaboration operations. For example, the network and UEs may exchange transmissions via uplink, downlink, and/or sidelink communications over the communication links and engage in UE collaboration and assistance operations as illustrated in the example of FIG. 4. This enhanced UE collaboration and assistance enables non-connected devices (e.g., RRC inactive or idle devices) to provide information about the non-connected devices indirectly to the network via another UE that is connected to the network to enable improved NES and RACH adaptation operations. The enhanced UE collaboration operations may be achieved by transmitting UE assistance information about non-connected devices to another UE via a non-Uu communication link (e.g., local wireless link, sidelink, etc.) and the other UE (e.g., relay or assisting) transmits or relays the UE assistance information to the network. These enhanced UE collaboration operations may provide additional information to the network to better guide when and how to perform NES operations and/or RACH adaptation operations.

In the example of FIG. 4, the UEs of the network may engage in one or more UE collaboration operations. For example, the UE 115 and/or the second UE 403 may each transmit or receive one or more UE collaboration transmissions to establish a communication link and UE collaboration capabilities, and to enable the UE 115 to provide UE assistance to the second UE 403. During the UE collaboration operations, the UEs may exchange UE collaboration information 408 and/or may perform the UE collaboration operations based on the NES configuration information 406, the UE collaboration information 408, and/or the settings information 444. Additionally, as part of the UE collaboration operations or after the collaboration operations have been performed, the second UE 403 may provide information to the UE 115 to enable the UE 115 and/or base station 105 to provide assistance to the second UE 403. The collaboration operations may occur via the network (e.g., via cellular communication) or via a local wireless communication.

As illustrated in the example of FIG. 4, the second UE 403 transmits a UE assistance transmission 452 to the UE 115 including UE assistance information 442. The second UE 403 may not be connected to network and/or may be out of range of the base station 105, and thus the second UE 403 may not be able to transmit the information and/or request for assistance directly to the network. The UE assistance information 442 may include information about the second UE 403 and includes information about a UE assistance request. The UE assistance request may be directed to or for a target cell, such as the base station 105 and may request a particular type of assistance (e.g., RACH adaptation). In some aspects, the UE assistance transmission 452 further includes adaptation information (e.g., an adaptation request) specifying a requested change to satisfy the UE assistance request, such as to activate a second set of previously configured and deactivated RACH resources. The UE assistance transmission 452 may include or correspond to a PSCCH, a PSSCH, a SCI, a SL-MAC-CE, or a SL-RRC message or a transmission via a local wireless network (e.g., a Bluetooth or Wi-Fi transmission). Alternatively, the transmission may correspond to a Uu transmission that was relayed via the cellular network or another network where the application data thereof indicates the request. Examples of such UE assistance transmissions are described further with reference to FIGS. 5-7.

The UE 115 generates and transmits a UE assistance request transmission 454 based on the received UE assistance transmission 452. For example, the UE 115 generates the UE assistance request transmission 454 based on the UE assistance information 442. In some examples, the UE 115 may relay the UE assistance transmission 452 to the base station 105 or may relay at least a portion of the UE assistance information 442 to the base station 105. In some such aspects, the UE 115 may relay the transmission or information thereof based on the UE assistance information 442. For example, the UE 115 may determine whether or not to transmit/relay the request based on the type of request, the information about the status and/or situation of the second UE 403, the request adaptation, or a combination thereof, indicated by the UE assistance information 442. In some such aspects, the UE 115 may also determine whether to transmit or relay the UE assistance request based on its own information (e.g., assisting UE information). For example, the UE 115 may determine to accept the request and provide the information and request to the network when the UE 115 has sufficient battery power, is in a particular mode (e.g. not a lower power mode), is connected to the network, has a latency below a latency threshold, etc., or a combination thereof. The UE assistance transmission 452 may include or correspond to an uplink transmission, and examples of such transmissions and report transmission schemes are described further with reference to FIGS. 5-7.

The base station 105 receives the UE assistance request transmission 454 from the UE 115 and regarding the second UE 403. The base station 105, such as the UE assistance manager 440 thereof, may determine to grant or deny a UE assistance request of the UE assistance request transmission 454 and may optionally determine one or more adaptation/remediation actions based on the UE assistance information 442 (e.g., assistance request information, assisted UE information, assisting UE information, or a combination thereof) of the UE assistance request transmission 454. The base station 105 may then generate adaptation or remediation information, adaptation information 443, based on the NES configuration information 406, the received UE assistance information 442 of the UE assistance request transmission 454, and/or the settings information 444. To illustrate, the base station 105 may transmit a response to the UE assistance request including adaptation/remediation action or the adaptation information 443. The response and adaptation information 443 may be transmitted (e.g., by unicast, broadcast, or backhaul) to another base station, the UE 115, the second UE 403, or a combination thereof.

As illustrated in the example of FIG. 4, the base station 105 generates and transmits a UE assistance response transmission 456 based on the received UE assistance request transmission 454. For example, the base station 105 generates the UE assistance response transmission 456 based on the UE assistance information 442 of the UE assistance request transmission 454 and transmits the UE assistance response transmission 456 to the UE 115. As another example, the base station 105 broadcasts the UE assistance response transmission 456 to multiple UEs, including the UE 115, the second UE 403, and optionally to one or more other UEs (e.g., a group of UEs). In some such aspects, where the base station 105 transmits the UE assistance response transmission 456 to the UE 115, the UE 115 generates and transmits a UE assistance response relay transmission 458 to the second UE 403. For example, the UE 115 generates the UE assistance response relay transmission 458 based on the UE assistance response transmission 456 or the adaptation information 443 thereof.

A device (e.g., the second UE 403) which receives the UE assistance response transmission 456 and/or the adaptation information 443 may then adjust a setting or configuration or operate with adjusted settings or configurations to establish a connection (e.g., connect), reestablish a connection (e.g., reconnect), perform handover or reselection operations, improve an active connection, enable a relay connection, reduce interference, reduce or recover from failures (e.g., beam and/or radio link), or a combination thereof, at the UE 115. For example, the UE 115 and/or second UE 403 receives the adaptation information 443 and may adjust a RACH resource for connection/reconnection or may adjust a dynamic grant, a configured grant, a slot format, a BWP, etc., to avoid errors and/or failures. As another example, the UE 115 and/or second UE 403 may adjust a transmission power or beam parameter to avoid errors and/or failures. Additionally, or alternatively, other devices may adjust a configuration or setting to reduce errors and/or failures at the UE 115 and/or second UE 403. For example, the second UE 403 may adjust one or more of the configurations or settings discussed above to reduce errors and/or failures at or experienced by the UE 115 or vice versa. Although the example of FIG. 4 has been explained with reference NES and/or RACH adaptation operations, in other implementations, the devices may additionally or alternatively report information for and remediate beam failures, handover failures, connection failures, reselection operations, handover operations, suspend/resume operations, and the like. The UE assistance information may be reported with the UE assistance request or report (e.g., in the same transmission or report) or in addition to the UE assistance request or report (e.g., in another transmission).

Accordingly, the network (e.g., the base station 105, the UE 115, and the second UE 403) may be able to more efficiently and effectively perform NES operations, including RACH adaptation operations for NES network entities. The improved NES and RACH adaptation operations may reduce power consumption while also reducing access latency for devices attempting to connect or reconnect to the network. Accordingly, the network performance and experience may be increased due to the network having increased visibility and information regarding non-connected devices when making NES and/or RACH adaptation decisions and due to reductions in access latency for non-connected devices and devices recovering from failure (e.g., RACH operations after beam or radio link failure).

Referring to FIG. 5, FIG. 5 is a timing diagram 500 illustrating a wireless communication system that supports enhanced UE collaboration operations according to one or more aspects. The example of FIG. 5 corresponds to an example of enhanced UE collaboration operations for assisted RACH operations. The assisted RACH operations may enable network entities operating in an energy savings mode and/or with multiple sets of RACH resources to activate a RACH resource or resources for dynamic, on-demand usage for remote/assisted UEs.

The example of FIG. 5 includes similar devices to the devices described in FIGS. 1, 2, and 4, such as a UE 115 (e.g., a first UE), a second UE 503 (e.g., second UE 403), and a network entity (e.g., base station 105). The devices of FIG. 5 may include one or more of the components as described in FIGS. 2 and 4. In FIG. 5, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, the network entity may include or correspond to multiple TRPs of a single base station (e.g., base station 105), to multiple base stations, or any combination thereof.

At 510, the base station 105 and the UE 115 establish a Uu communication link (also referred to as Uu link or UL/DL link). For example, the UE 115 may perform RRC, RACH, and/or connection establishment operations to establish (or re-establish) an uplink and downlink communication link with a node of a network, such as base station 105. In some implementations, the communication link may be established as part of a handover operation or through another UE. As illustrated in the example of FIG. 5, the base station 105 and UE 115 may communicate higher layer signaling, such as RRC signaling (e.g., a RRC transmission or message) or control layer signaling, to establish the connection and link.

At 515, the UE 115 and the second UE 503 establish a communication link. For example, the UE 115 may perform RRC, RACH, and/or connection establishment operations to establish (or re-establish) a direct, device-to-device communication link with another UE, such as a PC5 link or sidelink communication link. The second UE 503 may be connected to the network (e.g., the cellular network) at the time of connection establishment with the UE 115 in some aspects. To illustrate, the second UE 503 may be connected to, or may have previously been connected to, the base station 105 or another node of the network, such as a second base station (not shown). As another example, the second UE 503 may be connected to another network and may be connected to the UE 115 via the other network, such as via a local wireless connection (e.g., Wi-Fi, Bluetooth, etc.) or via an application or server. In such aspects, discovery and connection establishment operations may be performed via the other network and/or via an application/server (e.g., application data received via a cellular or local wireless connection). In some implementations, the communication link may be established as part of a group connection operation or through another UE (e.g., relay UE when the second UE is a remote UE and outside of communication range of the base station 105 and/or UE 115).

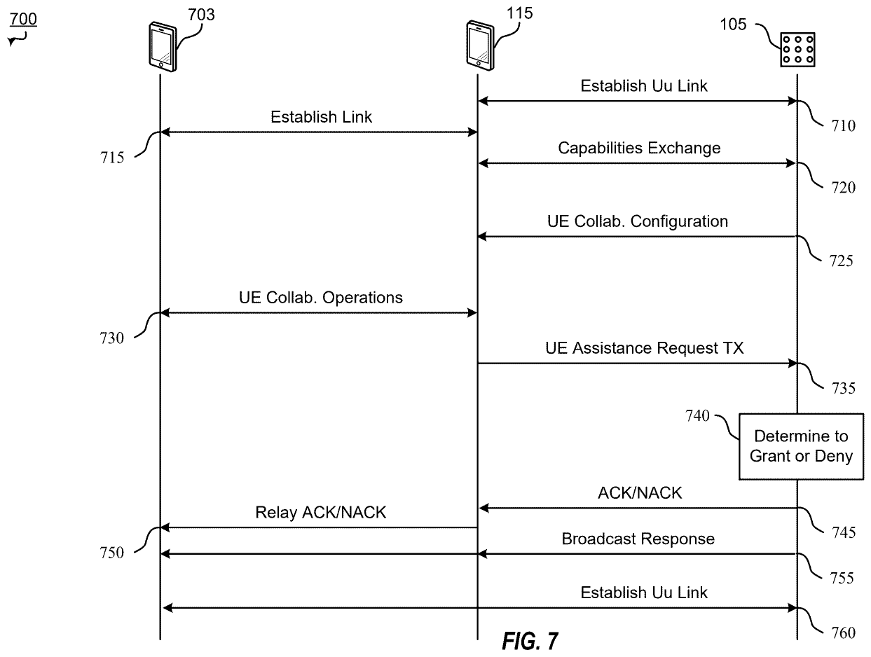

As illustrated in the example of FIG. 5, the UE 115 and second UE 503 may communicate higher layer signaling, such as RRC signaling (e.g., a RRC transmission or message) or control layer signaling, to establish the connection. Although one UE collaboration link is illustrated in the example of FIG. 5, the UE 115 and/or the second UE 503 may have multiple UE collaboration links at one time. An example of an assisting UE assisting multiple assisted/remote UEs, such as UEs of a particular group, is further illustrated and described with reference to FIG. 7.

After establishing the Uu communication link, the base station 105 and the UE 115 may perform UE collaboration configuration operations at 520 to configure the UE 115 for UE collaboration/assistance operations. For example, the base station 105 and the UE 115 may communicate or exchange one or more UE collaboration capability and/or configuration transmissions at 520. To illustrate, the UE 115 may receive downlink transmissions from the base station 105 and/or transmit uplink transmissions to the base station 105, such as to communicate UE collaboration settings, modes, thresholds, capabilities, etc. Although such operations are indicated after establishment of the UE collaboration link at 515, the transmissions may occur prior to establishment of the UE collaboration link at 515, or both prior to and after the establishment of the UE collaboration link at 515.

After establishing the UE collaboration communication link, the UE 115 and the second UE 503 perform UE collaboration configuration operations at 525 to configure the UE 115, the second UE 503, or both for UE collaboration/assistance operations. For example, the UE 115 and the second UE 503 may communicate or exchange one or more UE collaboration capability and/or configuration transmissions at 525. To illustrate, the UE 115 may receive downlink transmissions from the second UE 503 relayed by a base station (e.g., base station 105) or access point and/or may receive sidelink transmissions or D2D transmissions directly from the second UE 503. Additionally, or alternatively, the UE 115 may transmit uplink transmissions to the base station 105 for relay to the second UE 503, or may transmit sidelink transmissions or D2D transmissions directly to the second UE 503. The transmission(s) between the UE 115 and the second UE 503 may be used to communicate UE collaboration settings, modes, thresholds, capabilities, etc. Although the establishment of the UE collaboration link and the UE collaboration configuration operations are illustrated as occurring after the establishment of the Uu link at 510 and the network's configuration of the UE 115 for UE collaboration operations at 52 respectively, in other implementations the establishment of the UE collaboration link at 415 and/or the UE collaboration configuration operations transmissions at 525 may occur prior to the establishment of the Uu link and/or the Uu UE collaboration configuration operations. Additionally, or alternatively, the network may configure the second UE 503 to perform UE collaboration configuration operations. For example, the base station 105 or another base station of the network may configure the second UE 503 when the second UE 503 was previously connected to the network. In some such aspects, the network (e.g., base station 105) may instruct the two UEs to collaborate with each other or enable the two UEs to collaborate with each other (e.g., perform UE collaboration configuration operations at 525). The UE collaboration information exchanged at 520 and 525 may include or correspond to the UE collaboration information 408 of FIG. 4.

At 530, the second UE 503 may determine to perform RACH adaptation operations and/or UE collaboration operations. For example, the second UE 503 may determine that a connection to the network and/or to base station 105 is needed and that RACH operations are required to connect to the network. However, the RACH resources available to the second UE 503 and/or configured in general may not satisfy a requirement of the second UE 503 and/or may exceed a connection condition (e.g., a threshold amount of time), as described with reference to FIG. 3. To illustrate, the second UE 503 may have been paged, may have data to send, etc., and may have a connection cause (e.g., cause value) that is associated with a time value (e.g., RACH delay or absolute time) which is not satisfied by currently configured RACH resources. The second UE 503 may determine to request RACH adaptation operations or a specific RACH resource or resources to be activated. Additionally, the second UE 503 may determine that it needs to or that it would be more beneficial to (e.g., faster, lower latency, higher chance of success, etc.) engage in UE collaboration operations to initiate and/or complete the RACH adaptation operations.

At 535, the second UE 503 transmits UE assistance information to the UE 115. For example, a UE assistance manager 416 of the second UE 503 may generate UE assistance information based on the determination to perform RACH adaptation and/or on UE collaboration/assistance configuration information, and the second UE 503 includes the UE assistance information in a UE assistance transmission (e.g., a UE assistance RACH adaptation transmission). The second UE 503 may transmit the UE assistance transmission (or a UE collaboration transmission) to the UE 115 in a sidelink transmission directly or via a local wireless communication. When using a local wireless communication, the device may be connected directly (e.g., both the UE 115 and the second UE 503 are connected to each other via Wi-Fi), or the second UE 503 may be connected to an application server via the local wireless connection and utilize the application server to relay application data to the UE 115 to transmit the UE assistance information to the UE 115.

The UE assistance information may include or correspond to the UE assistance information 442 of FIG. 4. The UE assistance information may include information about the capabilities of the second UE 503, information about the communication link or links of the second UE 503, information about a state or status of the second UE 503, information about the requested connection of the second UE 503, information about the requested RACH adaptation for the second UE 503. In some aspects, the UE assistance information may include one or more of any of the above information for a group of UEs which includes the second UE 503, including for third and/or fourth UEs of the groups.

The information about the capabilities of the second UE 503 may include a type of the UE (e.g., RedCap, IoT, advanced, etc.), synchronization signal blocks (SSBs) supported by the UE, power level (PL) thresholds, supported capabilities, device identifier (ID) information (e.g., full device ID, partial device ID, group ID), etc. The information about the communication link or links of the second UE 503 may include a connection status, connection history information, RRC status, local connection status, RACH repetition information, link metric information (e.g., quality level, signal strength, PL, latency, or error rate), etc. The information about a state or status of the second UE 503 may include a mobility state, a power state, a connection state, an RRC state, colocation status, etc. The information about the requested connection of the second UE 503 may include target cell information (e.g., target cell or cells ID), cause value information, current RACH delay, target connection time or latency, etc. The information about the requested RACH adaptation for the second UE 503 may include a configured RACH resource to activate, a configured set of RACH resources to activate, a RACH timing parameter adjustment (e.g., window, repetition rate, or occasion) etc.

As illustrative, non-limiting examples of the UE assistance information, the UE assistance information may include information indicating one or more of: SSB(s) associated with the assisted UE, a type of UE of the assisted UE (e.g., RedCap, etc.), RACH repetition information for the assisted UE, estimated power level (PL) of the assisted UE, estimated reference signal received power (RSRP) of the assisted UE, estimated channel quality metrics of the assisted UE, a mobility state of the assisted UE, a full or partial identifier (e.g., I-RNTI or TMSI) of the assisted UE, a colocation status of the assisted UE (e.g., whether the assisted UE is collocated or not with the assisting UE and/or other group UEs), capability information of the assisted UE, a cause value for the assisted UE establishing a connection, or features supported by the assisted UE (e.g., to facilitate feature-specific RACH adaptations or other types of adaptations or specific parameters or modes thereof).

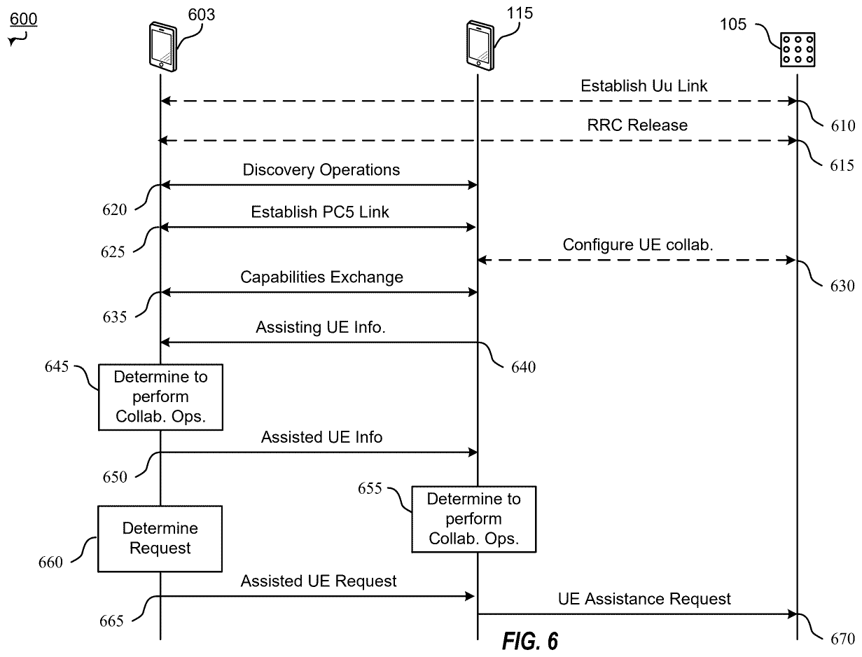

In some implementations, additional operations may be performed between the UE 115 and the second UE 503 in order to enable and/or perform the UE collaboration operations. One additional example of such UE-to-UE operations for UE collaboration setup and performance is illustrated and described further with reference to FIG. 6.

At 540, the UE 115 transmits a UE assistance request to the base station 105 based on the received UE assistance information. For example, the UE 115 relays at least a portion of the UE assistance information received from the second UE 503 to the base station 105. As another example, the UE 115 generates UE assistance information (e.g., second UE assistance information) or UE collaboration information that is based on the received UE assistance information from the second UE 503. In some implementations, the UE 115 may also include assisting UE information in the UE assistance information (or UE collaboration information) transmitted to the base station 105. For example, the UE 115 may include information about the UE 115 generally, and/or information about the communication link between the UE 115 and the second UE 503 to aid the base station 105 in making a decision to grant the UE assistance request.

The UE assistance request may be included in a UE assistance request transmission or UE collaboration request transmission. The transmission may include or correspond to a Wake-Up signal (WUS), a scheduling request (SR), a physical uplink shared channel (PUSCH) transmission, a physical uplink control channel (PUCCH) transmission, or a Random Access Channel (RACH) message. The RACH message may include or correspond to a MSG1 transmission, a MSG3 transmission, or a msgA transmission (e.g., a preamble and/or payload thereof). The UE assistance request transmission may include or correspond to the UE assistance request transmission 454 of FIG. 4.

In some implementations, additional operations may be performed between the UE 115 and the network (e.g., the base station 105) in order to enable and/or perform the UE collaboration operations. One additional example of such operations for UE collaboration setup and performance is illustrated and described further with reference to FIG. 7.

At 545, the base station 105 determines to perform UE assistance for the second UE 503 based on the UE assistance request from the UE 115. For example, the base station 105 determines to perform UE assistance based on the UE assistance request indication and optionally the UE assistance information included in the UE assistance request transmission from the UE 115. Additionally, the base station 105 may determine to perform UE assistance based on UE assistance information configuration settings information, operational parameters, etc. The base station 105 may determine to grant the UE assistance request or deny the UE assistance request. When granting the UE assistance request, the base station 105 may determine to grant the specific request (e.g., activate a particular RACH resource or perform a specifically requested action) or the base station 105 may determine to grant the request generally but not the specific requested action (if one is included).

In some such aspects, the base station 105 may optionally determine UE assistance request remediation information, such as when the specific requested action is not included or is denied by the base station 105. The UE assistance request remediation information may indicate a particular action or change determined by the base station 105 to assist the second UE 503. In the RACH example of FIG. 5, this may include determining RACH resources to activate, determining whether to activate a requested RACH resource or set of resources, determining an adjustment to RACH resources, etc. In other examples (e.g., non-RACH assistance examples), the base station 105 may determine to perform a handover, change a system setting, adjust scheduling information, adjust transmission power information, relay information to other network cells via a backhaul connection, etc. The UE assistance request remediation information may include or correspond to the adaptation information 443 of FIG. 4.

At 550, the base station 105 may transmit a UE assistance request response to UE 115 based on the received UE assistance request for the second UE 503 from the UE 115. For example, the base station 105 transmits an indication (e.g., ACK/NACK) indicating whether the base station 105 has granted or denied the UE assistance request, and optionally whether the base station 105 has granted or denied the requested specific UE assistance adaptation. Additionally, the UE assistance response may include the UE assistance request remediation information determined by the base station 105. In the RACH example of FIG. 5, the base station 105 may indicate a particular RACH resource or set of resources has been activated for the second UE 503 and optionally other UEs.

In some such aspects, the base station 105 may broadcast a UE assistance response including the indication or the UE assistance request remediation information in addition to the transmission sent to the UE 115 or in alternative to the transmission sent to the UE 115. For example, the base station 105 may broadcast a MIB or SIB message including RACH configuration information that activates previously deactivated resources, such as a second set of RACH resources previously deactivated for network energy savings. In non-RACH examples, the base station 105 may broadcast a transmission indicating a change, such as configuration adjustment or setting modification, and the change may be indicated by a higher layer configuration or parameter. As illustrative, non-limiting examples, the change may include a change in slot settings (e.g., slot format), transmission timing (e.g., configured grant timing, dynamic grant timing, etc.), transmission power, beam information, or a combination thereof. When broadcasting a response to the UE assistance request from the UE 115 and for the second UE 503, the second UE 503 may optionally receive the broadcasted response from the base station 105.

Optionally, the base station 105 may perform one or more additional operations. For example, the base station 105 may transmit the UE assistance request remediation information to another base station via a backhaul connection, and the other base station may implement the action determined by the base station 105 and generated to address the UE assistance request from the second UE 503. For example, the second base station may transmit or broadcast a transmission to the second UE 503 indicating the UE assistance request remediation information or a changed configuration (e.g., RACH configuration, beam configuration, scheduling configuration, etc.).

At 555 the UE 115 optionally transmits a UE assistance response to the second UE 503. For example, the UE 115 may relay the received indication and/or UE assistance request remediation information from the base station 105 to the second UE 503. The UE 115 may transmit a sidelink transmission directly to the second UE 503 or may transmit an uplink transmission to a relay device that relays the uplink transmission (or the data thereof) to the second UE 503.

At 560, the base station 105 and the second UE 503 establish a Uu communication link (also referred to as Uu link or UL/DL link). For example, the second UE 503 may perform RRC, RACH, and/or connection establishment operations to establish (or re-establish) an uplink and downlink communication link with a node of a network, such as the base station 105 based on the UE assistance response from the UE 115. As illustrated in the example of FIG. 5, the base station 105 and the second UE 503 may communicate higher layer signaling, such as RRC signaling (e.g., a RRC transmission or message) or control layer signaling, to establish the connection and link based on the response from the base station 105 that was relayed from the UE 115. For example, the response received at 555 may include an indication that the UE assistance request was granted, an indication of activated configured RACH resources (e.g., reactivation of a deactivated set of RACH resources), or may include dedicated RACH resources for the second UE 503. As another example, the response may include an indication that the UE assistance request was granted (e.g., an ACK), and the second UE 503 may determine to monitor for a SIB message indicating activated RACH resources or dedicated RACH resources. In other aspects, the grant indication and the RACH resources may be sent in multiple transmissions.

Referring to FIG. 6, FIG. 6 is a timing diagram 600 illustrating a wireless communication system that supports enhanced UE collaboration operations according to one or more aspects. The example of FIG. 6 corresponds to an example of enhanced UE collaboration operations with a focus on additional operations by UEs to enable transmission of UE assistance information to a network entity. As compared to the example of FIG. 5, the example of FIG. 6 is not described with reference to RACH operations and includes additional optional operations between the UEs. The UE collaboration operations may include the information described with reference to FIGS. 4 and/or 5 or with reference to any of FIGS. 6 and 7.

The example of FIG. 6 includes similar devices to the devices described in FIGS. 1, 2, and 4, such as a UE 115 (e.g., a first UE), a second UE 603 (e.g., second UE 403 or 503), and a network entity (e.g., base station 105). The devices of FIG. 6 may include one or more of the components as described in FIGS. 2 and 4. In FIG. 6, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

In some aspects, the base station 105 and the second UE 503 may have been connected previously, such as to discover UEs capable of providing UE assistance and to configure UE collaboration/assistance operations between UEs. After configuration, the second UE 503 may release the connection for any reason. For example, at 610, the base station 105 and the second UE 503 establish a Uu communication link as described with reference to 510 of FIG. 5. At 615, the base station 105 and the second UE 503 may release or suspend the connection by performing RRC release operations, and the second UE 503 may transition from an RRC connected mode to an RRC idle or inactive mode. In the example illustrated in FIG. 6, the base station 105 may transmit a connection release message to the second UE 503 at 620. For example, the base station 105 may transmit a RRC or other higher layer message to the second UE 503 to release or suspend the Uu connection. As one example illustration, the base station 105 may transmit a RRC release message (with or without a suspend indication) to the UE 115 to release or suspend the Uu connection.

At 620, the UE 115, the second UE 603, or both, may perform device discovery operations, such as sidelink device discovery, local wireless connection discovery, or discovery via an application. This may include broadcasting discovery beacons and/or system information messages, receiving and responding to such messages, or transmitting application data to an application server to facilitate discovery operations. In the example of FIG. 6, the UEs perform sidelink discovery operations, and the sidelink discovery operations may be performed directly or via the network (e.g., relayed and/or scheduled by the base station 105). In some aspects, the UE 115 and the second UE 603 perform discovery operations while the second UE 603 is still connected to the network, such as prior to release of the second UE 603 at 615.

At 625, the UE 115, the second UE 303, or both may perform sidelink connection establishment operations, such as sidelink device connection establishment operations. For example, the UE 115 may transmit a connection establishment request to the second UE 603 directly or via the base station 105. For example, the UE 115 may transmit a higher layer message or transmission requesting to perform connection establishment operations responsive to and based on the discovery operations performed. In other examples, the second UE 603 may transmit the higher layer message or transmission requesting to perform connection establishment operations. Additionally, or alternatively, the UE 115 or second UE 603 transmits a connection establishment setup message to the other UE directly or via the base station 105, such as responsive to the connection establishment request message. In some other aspects, the base station 105 generates and transmits the connection establishment message responsive to the connection establishment request message from one or more of the UEs.

At 630, the base station 105 and the UE 115 may perform UE collaboration configuration operations, similar to the UE collaboration configuration operations performed at 520 of FIG. 5, to configure the UE 115 for UE collaboration/assistance operations. For example, the base station 105 and the UE 115 may communicate or exchange one or more UE collaboration capability and/or configuration transmissions at 630. To illustrate, the UE 115 may receive downlink transmissions from the base station 105 and/or transmit uplink transmissions to the base station 105, such as to communicate UE collaboration settings, modes, thresholds, capabilities, etc. Additional details of the configuration operations of the UE 115 for UE collaboration are illustrated and described further with reference to FIG. 7. The UE collaboration configuration may enable the UE 115 to receive UE assistance information from one or more other UEs (e.g., the second UE 603) and to relay the UE assistance information to the network (e.g., the base station 105).

At 635, the UE 115 and the second UE 603 perform capabilities exchange operations for UE collaboration/assistance operations. For example, either UE or both may advertise their own supported UE collaboration/assistance operation capabilities in a broadcast transmission or in a unicast transmission. To illustrate, either UE or both may transmit UE collaboration/assistance capabilities information and/or UE collaboration/assistance configuration information indicating how the UE may be configured by the network (e.g., base station 105).

At 640, the UE 115 transmits assisting UE information to the second UE 603. For example, a UE assistance manager 416 of the UE 115 may generate UE assistance information based on a determination that the second UE 603 is capable of performing UE collaboration/assistance operations, and the UE 115 includes the UE assistance information in a UE assistance transmission (e.g., a UE assistance RACH adaptation transmission). The UE 115 may transmit the UE assistance transmission (or a UE collaboration transmission) to the second UE 603 in a sidelink transmission directly or via a local wireless communication. When using a local wireless communication, the device may be connected directly (e.g., both the UE 115 and the second UE 603 are connected to each other via Wi-Fi), or the UE 115 may be connected to an application server via the local wireless connection and utilize the application server to relay application data to the second UE 603 to transmit the UE assistance information to the second UE 603.

The assisting UE information may include or correspond to the UE assistance and/or collaboration information, or a portion thereof as described with reference to FIGS. 4 and 5. The assisting UE information may include or correspond to transmission latency information for the UE 115, serving cell information for the UE 115, RRC status information for the UE 115, battery power information for the UE 115, energy cost information for the UE 115, or a combination thereof. In a particular, non-limiting example, the UE collaboration information includes transmission latency information for the UE 115 (e.g., a transmission delay or round trip time (RTT) associated with the communication link between the UE 115 and the base station 105) and relay energy cost information for the UE 115 (e.g., an energy metric associated with receiving data from the second UE 603 and relaying the data to the base station 105).

At 645, the second UE 603 optionally determines whether to perform UE collaboration with the UE 115 and/or to seek UE assistance from the UE 115. For example, the second UE 603 may determine to transmit one or more UE assistance requests to the UE 115 based on the received assisting UE information, and optionally based on its own assisted UE information. In some such aspects, the second UE 603 determines to transmit the assisted UE information to the UE 115 based on and/or responsive to the receipt of the assisting UE information and optionally, based on one or more determinations made using the assisting UE information. For example, the second UE 603 may transmit assisted UE information, UE assistance requests, or both, to the UE 115 based on the received assisting UE information satisfying one or more corresponding conditions, such as when a latency of the UE and an energy cost are below network configured threshold values and/or below coordinated values determined during the collaboration operations.

At 650, the second UE 603 transmits assisted UE information to the UE 115. For example, a UE assistance manager 416 of the second UE 603 may generate UE assistance information based on the capabilities exchange and/or receipt of the assisting UE information, and the second UE 603 includes the UE assistance information in a UE assistance transmission (e.g., an assisted UE information transmission). The second UE 603 may transmit the UE assistance transmission (or a UE collaboration transmission) to the UE 115 in a sidelink transmission directly or via a local wireless communication. When using a local wireless communication, the device may be connected directly (e.g., both the UE 115 and the second UE 603 are connected to each other via Wi-Fi), or the second UE 603 may be connected to an application server via the local wireless connection and utilize the application server to relay application data to the UE 115 to transmit the UE assistance information to the UE 115. The assisted UE information may include or correspond to the UE assistance information, or a portion thereof as described with reference to FIGS. 4 and 5.

At 655, the UE 115 optionally determines whether to perform UE collaboration operations with and/or UE assistance operations for the second UE 603. For example, the UE 115 may determine to relay requests for second UE 603 to the base station 105 based on the transmitted assisting UE information, the received assisted UE information, or a combination thereof. For example, the UE 115 may compare the assisting UE information and/or the received assisted UE information to corresponding thresholds to determine if conditions are satisfied (or still satisfied) for providing collaboration and/or assistance. The determination may be similar to, or different from, the determination by the second UE 603 at 645.

At 660, the second UE 603 determines to request UE assistance from the UE 115. The second UE 603 may determine to request UE assistance based on one or more of its needs or requirements not currently being satisfied by a configuration of the network. For example, the network may be operating in a NES mode and may have deactivated configurations that the second UE 603 desires to use, such as configurations and/or resources thereof that can satisfy requirements or needs at the second UE 603. Additionally, after determining that it has an assistance request for the network and that it is not connected to the network, the second UE 603 may determine whether it is permitted to request that the UE 115 relay a UE assistance request or requests to the base station 105 for the second UE 603 based on the transmitted assisting UE information, the received assisted UE information, or a combination thereof. In some aspects, the second UE 603 may receive an acknowledgement or other transmission from the UE 115 responsive to the transmission of the assisted UE information at 650. For example, the UE 115 may transmit whether it will provide assistance to the second UE 603 (e.g., relay UE assistance information and requests to the network) based on the determination at 655.

At 670, the UE 115 transmits a UE assistance request to the base station 105 based on the received assisted UE information. For example, the UE 115 relays at least a portion of the assisted UE information received from the second UE 603 to the base station 105. As another example, the UE 115 generates UE assistance information that is based on the received assisted UE information from the second UE 603. In some implementations, the UE 115 may also include the assisting UE information in the UE assistance information (or UE collaboration information) transmitted to the base station 105. For example, the UE 115 may include information about the UE 115 generally, and/or information about the communication link between the UE 115 and the second UE 603 to aid the base station 105 in making a decision to grant (or deny) the UE assistance request. After 670, the devices may perform UE assistance/collaboration operations, such as those as described with reference to FIG. 5 or 7.

Referring to FIG. 7, FIG. 7 is a timing diagram 700 illustrating a wireless communication system that supports enhanced UE collaboration operations according to one or more aspects. The example of FIG. 7 corresponds to an example of enhanced UE collaboration operations with a focus on additional, operations between the assisting UE and network UEs to enable transmission of UE assistance information to a network entity. As compared to the example of FIG. 5, the example of FIG. 7 is not described with reference to RACH operations and includes additional optional operations between the assisting UE and network. The UE collaboration operations may include the information described with reference to FIGS. 4-6.

The example of FIG. 7 includes similar devices to the devices described in FIGS. 1, 2, and 4, such as a UE 115 (e.g., a first UE), a second UE 703 (e.g., second UE 403, 503, or 603), and a network entity (e.g., base station 105). The devices of FIG. 7 may include one or more of the components, as described in FIGS. 2 and 4. In FIG. 7, these devices may utilize antennas 252a-r, transmitter 410, receiver 412, encoder 413, and/or decoder 414, or may utilize antennas 234a-t, transmitter 434, receiver 436, encoder 437, and/or decoder 438 to communicate and receive transmissions. In some implementations, the network entity may include or correspond to multiple TRPs of a single base station (e.g., base station 105), to multiple base stations, or any combination thereof.

At 710, the base station 105 and the UE 115 establish a Uu communication link, as described with reference to 510 of FIG. 5. At 715, the UE 115 and the second UE 703 establish a communication link as described with reference to 515 of FIG. 5. As described with reference to FIG. 5, the UE 115, the second UE 703, and the base station 105 may communicate with each other over the communication links by transmitting and/or receiving transmissions.

At 720, the UE 115 and the base station 105 perform capabilities exchange operations for UE collaboration/assistance operations, similar to the capabilities exchange operations performed at 635 of FIG. 6. For example, either the UE 115 or the base station 105 may advertise their own supported UE collaboration/assistance operation capabilities in a broadcast transmission or in a unicast transmission. To illustrate, the base station 105 may request that the UE 115 report its UE collaboration/assistance capabilities information and/or UE collaboration/assistance configuration information indicating what the UE is capable of. As another illustration, the base station 105 may advertise what collaboration/assistance operations are supported or allowed by the network.

At 725, the base station 105 and the UE 115 may perform UE collaboration configuration operations, similar to the UE collaboration configuration operations performed at 520 of FIG. 5, to configure the UE 115 for UE collaboration/assistance operations. For example, the base station 105 and the UE 115 may communicate or exchange one or more UE collaboration capability and/or configuration transmissions at 725. To illustrate, the UE 115 may receive downlink transmissions from the base station 105 and/or transmit uplink transmissions to the base station 105, such as to communicate UE collaboration settings, modes, thresholds, capabilities, etc.

At 730, the UE 115 and the second UE 703 may perform the UE collaboration/assistance operations, as described with reference to FIGS. 4-6. For example, the second UE 703 may transmit UE assistance information to the UE 115 indicating a UE assistance request (e.g., UE assistance information) for relay to the network, similar to the operations at 555 of FIG. 5. As another example, the UE 115 and the second UE 703 may perform one or more of the UE collaboration/assistance operations at 620-665 of FIG. 6.

At 735, the UE 115 transmits a UE assistance request to the base station 105, based on the UE collaboration operations (e.g., UE assistance information received therein), similar to the UE assistance request transmitted at 540 of FIGS. 5 and/or 670 of FIG. 6. For example, the UE 115 relays at least a portion of the UE assistance information received from the second UE 703 to the base station 105. As another example, the UE 115 generates UE assistance information (e.g., second UE assistance information) or UE collaboration information that is based on the received UE assistance information from the second UE 703. In some implementations, the UE 115 may also include assisting UE information in the UE assistance information (or UE collaboration information) transmitted to the base station 105. For example, the UE 115 may include information about the UE 115 generally, and/or information about the communication link between the UE 115 and the second UE 703 to aid the base station 105 in making a decision to grant the UE assistance request.

At 740, the base station 105 determines to grant or deny the UE assistance request. For example, the base station 105 determines to grant or deny the UE assistance request indicated in the UE assistance request based on base station performance data, base station configuration data, base station settings date (e.g., configured network settings), UE assistance data, or a combination thereof. To illustrate, the base station 105 may evaluate a UE assistance request, based on assisting UE data and/or assisted UE data associated with the UE assistance request and optionally, based on one or more other UE assistance requests. As an illustrative example, the base station 105 may determine to grant a UE assistance request based on receiving a number of similar UE assistance requests within a threshold time period. As another illustrative example, the base station 105 may determine to grant a RACH-related UE assistance request based on a cause value and a current RACH delay associated with a RACH adaptation/activation request and optionally, based on a latency delay of the assisting UE (e.g., UE 115), satisfying the RACH delay.

In some aspects, the UE assistance request may indicate or request a specific action (e.g., remediation action or change) to the base station 105. In such aspects, the base station 105 may determine to grant the specific action separate from or with a generic request for assistance. To illustrate, a UE assistance request may indicate UE assistance of a RACH type and then may indicate a specific RACH resource activation or RACH resource reconfiguration (e.g., timing change, repetition rate change, etc.). The base station 105 may evaluate the requests (e.g., general and specific or request and fix) separately or together. The base station 105 may include different conditions or thresholds for granting a request and for implementing a specific adaptation action.

At 745, the base station 105 transmits a response to the UE assistance request (e.g., a UE assistance request response) to the UE 115. For example, the base station 105 transmits a positive indication (e.g., ACK) to the UE 115 indicating the UE assistance request from the second UE 703 is granted or transmits a negative indication (e.g., ACK) to the UE 115 indicating the UE assistance request from the second UE 703 is denied. To illustrate, the base station 105 may transmit a dedicated response transmission including an indicator (e.g., flag bit) or may transmit the indication in an acknowledgement transmission. Alternatively, the base station 105 may refrain from transmitting a response to the UE assistance request from the second UE 703, such as when denying the UE assistance request.

In some aspects, the response to the UE assistance request also includes assistance remediation information indicating a particular assistance action for the second UE 703. For example, in the RACH adaptation assistance example, the response may include an indication that a particular requested RACH resource or set of resources has been activated. Alternatively, the response may include an implicit indication of the particular remediation action when the request itself includes a requested remediation action, such as to activate the deactivated RACH resources.

At 750, the UE 115 transmits a response to the UE assistance request (e.g., a UE assistance request response) to the second UE 703. For example, the UE 115 relays the response or indication received from the base station 105 to the second UE 703. As another example, the UE 115 transmits a response to the UE assistance request, indicating that the UE 115 received the request, relayed the request, received an acknowledgement the relayed request was received by the base station 105, the relayed request was granted by the base station 105, or any combination thereof.

At 755, the base station 105 optionally broadcasts a response based on the UE assistance request. For example, the base station 105 may broadcast a response to the UE assistance request in addition to, or in the alternative of, transmitting the response to the UE 115 at 745. To illustrate, the base station 105 may broadcast a response in the alternative to the direct or unicast response to the UE 115 to reach the UE 115 and possibly other UEs, such as the second UE 503 and optionally, other UEs, which may or may not have sent their own UE assistance requests. As another illustration, the base station 105 may broadcast a response in addition to the direct or unicast response to the UE 115 to provide the second UE 703 and possibly other UEs in similar situations with adjusted configuration information, such as activated RACH resources in a SIB message.

At 760, the base station 105 and the second UE 703 establish a Uu communication link (also referred to as Uu link or UL/DL link), similar to the connection establishment operations performed at 560 of FIG. 5. For example, the second UE 703 may perform RRC, RACH, and/or connection establishment operations to establish (or re-establish) an uplink and downlink communication link with a node of a network, such as the base station 105 or another base station, based on the UE assistance response from the base station 105.

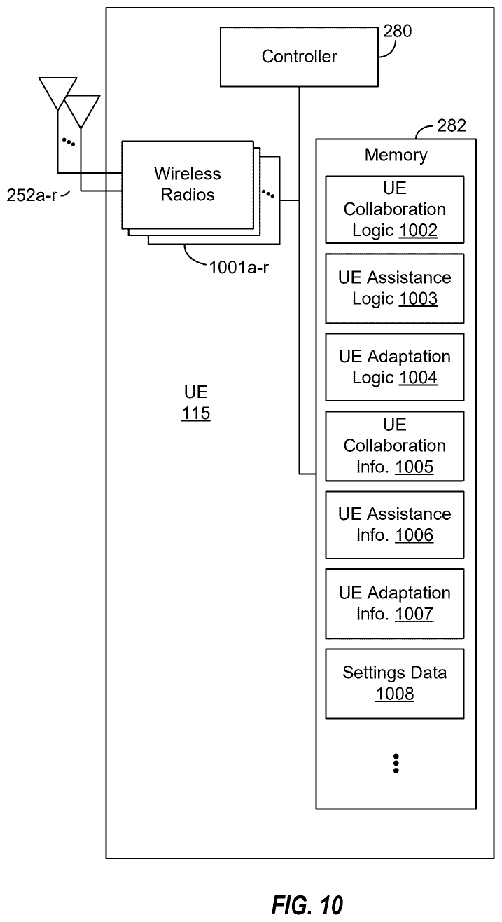

FIG. 8 is a flow diagram illustrating example blocks executed by a UE configured according to an aspect of the present disclosure. The example blocks will also be described with respect to UE 115, as illustrated in FIG. 10. FIG. 10 is a block diagram illustrating UE 115, configured according to one aspect of the present disclosure. UE 115 includes the structure, hardware, and components, as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1000a-r and antennas 252a-r. Wireless radios 1000a-r include various components and hardware, as illustrated in FIG. 2 for UE 115, including modulator/demodulators 254a-r, MIMO detector 256, receive processor 258, transmit processor 264, and TX MIMO processor 266.

At block 800, a wireless communication device, such as a UE, receives UE assistance information from a UE. For example, the UE 115 receives UE assistance information 442 from the second UE 403, as described with reference to FIG. 4. As another example, the UE 115 receives UE assistance information (e.g., collaboration information, assisted UE information, UE assistance request information, requested adaptation information, or a combination thereof) from the second UE 503, 603, or 703, as described with reference to any of FIGS. 5-7.

At block 801, the UE 115 transmits, to a network entity, a request for UE assistance based on the received UE assistance information from the UE. For example, the UE 115 transmits the UE assistance request transmission 454 to the base station 105, as described with reference to FIG. 4. As another example, the UE 115 transmits a UE assistance request transmission or report, including UE assistance information, to the base station 105 based on the received UE assistance information, as described with reference to FIGS. 5-7.

At block 802, the UE 115 receives UE assistance response information from the network entity responsive to transmission of the request for UE assistance. For example, the UE 115 receives the UE assistance response transmission 456, including the adaptation information 443, which was determined based on the UE assistance request, as described with reference to FIG. 4. Other examples are described with reference to FIGS. 5-7.

At block 803, the UE 115 transmits at least a portion of the UE assistance response information to the UE. For example, the UE 115 transmits the UE assistance response relay transmission 458 to the second UE 403 based on the received UE assistance response transmission 456, as described with reference to FIG. 4. The UE 115 transmits the UE assistance response relay transmission 458 which may include the adaptation information 443 or a portion thereof. Other examples are described with reference to FIGS. 5-7.

The UE 115 may execute additional blocks (or the UE 115 may be configured further to perform additional operations) in other implementations. For example, the UE 115 may perform one or more operations described above. As another example, the UE 115 may perform one or more aspects, as described below.

Accordingly, a UE and a base station may perform enhanced UE collaboration operations. By performing enhanced UE collaboration operations, energy consumption may be reduced with reduced impacts on performance.

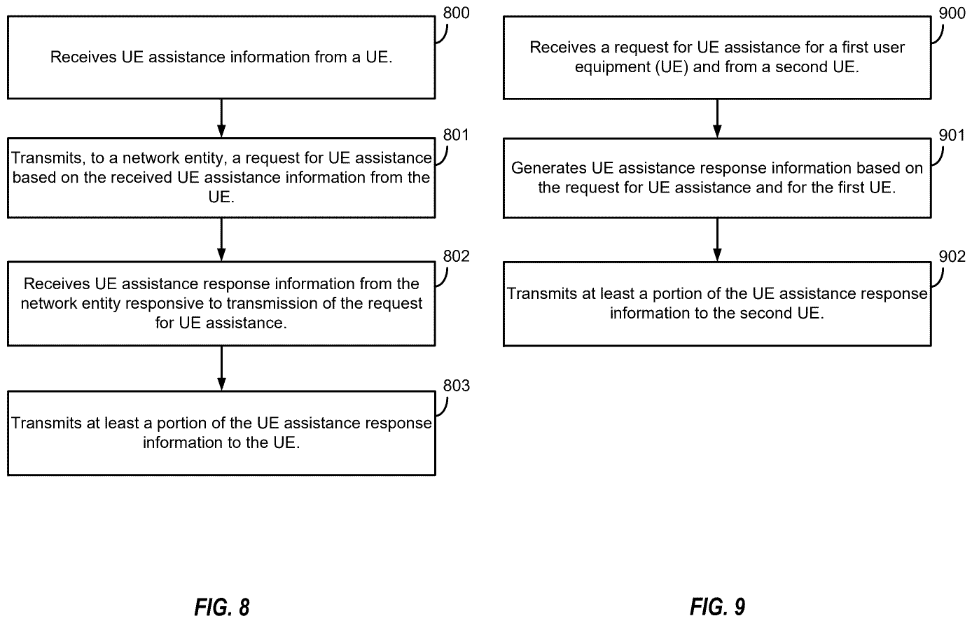

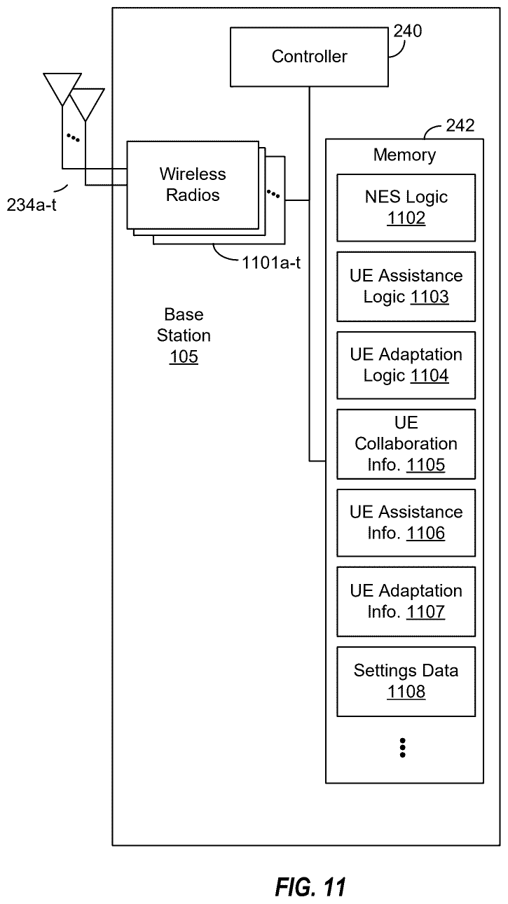

FIG. 9 is a flow diagram illustrating example blocks executed by a wireless communication device configured according to another aspect of the present disclosure. The example blocks will also be described with respect to base station 105 (e.g., gNB), as illustrated in FIG. 11. FIG. 11 is a block diagram illustrating base station 105 configured according to one aspect of the present disclosure. Base station 105 includes the structure, hardware, and components, as illustrated for base station 105 of FIG. 2. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1101a-t and antennas 234a-t. Wireless radios 1101a-t include various components and hardware, as illustrated in FIG. 2 for base station 105, including modulator/demodulators 234a-t, MIMO detector 236, receive processor 238, transmit processor 220, and TX MIMO processor 230.

At block 900, a wireless communication device, such as a base station, receives a request for UE assistance for a first user equipment (UE) and from a second UE. For example, the base station 105 receives the UE assistance request transmission 454 from the UE 115, as described with reference to FIG. 4. As another example, the base station 105 receives a UE assistance request transmission or report, including UE assistance information, from the UE 115, as described with reference to FIGS. 5-7.

At block 901, the wireless communication device generates UE assistance response information based on the request for UE assistance and for the first UE. For example, the base station 105 generates the UE assistance response transmission 456 and/or the adaptation information 443, as described with reference to FIGS. 4-7.

At block 902, the wireless communication device transmits at least a portion of the UE assistance response information to the second UE. For example, the base station 105 transmits the UE assistance response transmission 456, including the adaptation information 443, which was determined based on the UE assistance request, to the UE 115, as described with reference to FIG. 4. Other examples are described with reference to FIGS. 5-7

The base station 105 may execute additional blocks (or the base station 105 may be configured further to perform additional operations) in other implementations. For example, the base station 105 may perform one or more operations described above. As another example, the base station 105 may perform one or more aspects, as described below.

In a first aspect, a device for wireless communication includes at least one processor and a memory coupled to the at least one processor. The at least one processor is configured to cause the device to: receive UE assistance information from a user equipment (UE); transmit, to a network entity, a request for UE assistance based on the received UE assistance information from the UE; receive UE assistance response information from the network entity responsive to transmission of the request for UE assistance; and transmit at least a portion of the UE assistance response information to the UE.

In a second aspect, alone or in combination with the first aspect, the UE assistance information includes: information about the capabilities of the UE; information about the communication link or links of the UE; information about a state or status of the UE; information about the requested connection of the UE; information about the requested RACH adaptation for the UE; or any combination thereof. In a some such aspects, the UE assistance information may include information indicating one or more of: SSB(s) associated with the assisted UE, a type of UE of the assisted UE (e.g., RedCap, etc.), RACH repetition information for the assisted UE, estimated power level (PL) of the assisted UE, estimated RSRP of the assisted UE, estimated channel quality metrics of the assisted UE, a mobility state of the assisted UE, a full or partial identifier (e.g., I-RNTI or TMSI) of the assisted UE, a colocation status of the assisted UE (e.g., whether the assisted UE is collocated or not with the assisting UE and/or other group UEs), capability information of the assisted UE, a cause value for the assisted UE establishing a connection, or features supported by the assisted UE (e.g., to facilitate feature-specific RACH adaptations or other types of adaptations or specific parameters or modes thereof).

In a third aspect, alone or in combination with one or more of the above aspects, the request for UE assistance comprises an uplink Wake-Up signal (WUS), a scheduling request (SR), a physical uplink shared channel (PUSCH) transmission, a physical uplink control channel (PUCCH) transmission, or a Random Access Channel (RACH) message.

In a fourth aspect, alone or in combination with one or more of the above aspects, the RACH message is MSG1, MSG3, or msgA (e.g., preamble or payload).

In a fifth aspect, alone or in combination with one or more of the above aspects, the request for UE assistance comprises a UE assistance request transmission, including request information and including at least a portion of the UE assistance information.

In a sixth aspect, alone or in combination with one or more of the above aspects, the at least one processor is further configured to cause the device to: receive, from the network entity, a capabilities request transmission; and transmit a capabilities response transmission responsive to the capabilities request transmission and indicating UE collaboration and/or assistance capabilities of the device.

In a seventh aspect, alone or in combination with one or more of the above aspects, the request for UE assistance includes an indication of a UE assistance request and information regarding a corresponding requested adaptation for the UE assistance request (e.g., activate second set of RACH resources).

In an eighth aspect, alone or in combination with one or more of the above aspects, the network entity is operating in network energy saving mode, and wherein the device is configured with a first set of RACH resources and a second set of RACH resources, wherein the first set of RACH resources correspond to legacy RACH resources, and wherein the second set of RACH resources correspond to NES RACH resources.

In a ninth aspect, alone or in combination with one or more of the above aspects, the at least one processor is further configured to cause the device to: receive a system information block (SIB) message; and determine that the network entity has deactivated the second set of RACH resources based on the SIB message.

In a tenth aspect, alone or in combination with one or more of the above aspects, the RACH resources include one or more of preamble IDs, RACH occasions, PRACH configurations, or RACH beams.

In an eleventh aspect, alone or in combination with one or more of the above aspects, the at least one processor is further configured to cause the device to: perform UE discovery operations; establish a communication link with the UE; and exchange UE collaboration information with the UE.

In a twelfth aspect, alone or in combination with one or more of the above aspects, the at least one processor is further configured to cause the device to: determine whether one or more UE collaboration conditions for providing UE assistance to the UE are satisfied; and transmit an indication or capability for UE collaboration or assistance to the UE, the network entity, or both, based on a determination that the one or more UE conditions are satisfied.

In a thirteenth aspect, alone or in combination with one or more of the above aspects, the at least one processor configured to cause the device to determine whether one or more UE collaboration/assistance conditions are satisfied includes to: determine whether the one or more UE collaboration/assistance conditions are satisfied based on UE collaboration information, wherein the UE collaboration information includes transmission latency information (e.g., RTT between device and network), serving cell information (e.g., cell or cells connected to/camped on, RRC status info, etc.), RRC status information, battery power information, energy cost information, or a combination thereof, for the device.

In a fourteenth aspect, alone or in combination with one or more of the above aspects, the device is connected to the UE via a sidelink connection or via a local wireless connection

In a fifteenth aspect, alone or in combination with one or more of the above aspects, the at least one processor is configured to receive the UE assistance information from the UE includes to: receive the UE assistance information as application data from the network entity or from a second network entity.

In a sixteenth aspect, alone or in combination with one or more of the above aspects, the at least one processor is further configured to cause the device to: receive second UE assistance information from a second UE, wherein the UE and the second UE correspond to a group of UEs; and transmit, to the network entity, a second request for UE assistance based on the received second UE assistance information from the second UE, wherein the second request is transmitted in a same transmission as the request for UE assistance for the UE or in a different transmission.

In a seventeenth aspect, alone or in combination with one or more of the above aspects, the UE assistance information from the UE indicates assistance for the network entity, and wherein the device is connected to the network entity during receipt of the UE assistance information.

In an eighteenth aspect, alone or in combination with one or more of the above aspects, the UE assistance information from the UE indicates assistance for a second network entity, wherein the device is connected to the network entity and not connected to the second network entity, and wherein the at least one processor is further configured to: transmit an indication of the second network entity to the network entity.

In a nineteenth aspect, alone or in combination with one or more of the above aspects, the at least one processor is further configured to cause the device to: receive second UE assistance information from a second UE; transmit, to the network entity, a second request for UE assistance based on the received second UE assistance information from the second UE; receive second UE assistance response information from the network entity responsive to transmission of the second request for UE assistance and indicating a negative indication for UE assistance for the second UE; and transmit the negative indication to the second UE.

In a twentieth aspect, alone or in combination with one or more of the above aspects, the at least one processor is further configured to cause the device to: receive a system information block (SIB) message with updated RACH information, and wherein the updated RACH information: corresponds to a RACH configuration with one or more changed parameters or activation of a dedicated/pre-configured set of RACH resources; or includes a set of RACH preamble IDs, a RACH power configuration, a RACH timing adjustment, an activated RACH window, an activated RACH resource, or a combination thereof.

In a twenty-first aspect, alone or in combination with one or more of the above aspects, a device for wireless communication includes at least one processor and a memory coupled to the at least one processor. The at least one processor is configured to cause the device to: receive a request for UE assistance for a first user equipment (UE) and from a second UE; generate UE assistance response information based on the request for UE assistance and for the first UE; and transmit at least a portion of the UE assistance response information to the second UE.

In another aspect of the disclosure, alone or in combination with one or more of the above aspects, a method of wireless communication includes: receiving UE assistance information from a user equipment (UE); transmitting, to a network entity, a request for UE assistance based on the received UE assistance information from the UE; receiving UE assistance response information from the network entity responsive to transmission of the request for UE assistance; and transmitting at least a portion of the UE assistance response information to the UE.

Accordingly, a UE and a base station may perform enhanced UE collaboration operations. By performing enhanced UE collaboration operations, energy consumption may be reduced with reduced impacts on performance.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As a further example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station, it also discloses that a first network node is configured to receive information from a second network node, the first network node may refer to a first UE, a first base station, a first apparatus, a first device, a first computing system, a first set of one or more one or more components, a first processing entity, or the like configured to receive the information, and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-11 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device for wireless communication, comprising:
at least one processor; and
a memory coupled to the at least one processor, wherein the at least one processor is configured to cause the device to:
receive UE assistance information from a user equipment (UE);
transmit, to a network entity, a request for UE assistance based on the received UE assistance information from the UE;
receive UE assistance response information from the network entity responsive to transmission of the request for UE assistance; and
transmit at least a portion of the UE assistance response information to the UE.

2. The device of claim 1, wherein the UE assistance information includes:
information about capabilities of the UE;
information about a communication link or links of the UE;
information about a state or status of the UE;
information about a requested connection of the UE;
information about a requested RACH adaptation for the UE; or any combination thereof.

3. The device of claim 1, wherein the request for UE assistance comprises an uplink Wake-Up signal (WUS), a scheduling request (SR), a physical uplink shared channel (PUSCH) transmission, a physical uplink control channel (PUCCH) transmission, or a Random Access Channel (RACH) message.

4. The device of claim 3, wherein the RACH message comprises a MSG1 transmission, a MSG3 transmission, or a msgA transmission.

5. The device of claim 1, wherein the request for UE assistance comprises a UE assistance request transmission including request information and including at least a portion of the UE assistance information.

6. The device of claim 1, wherein the at least one processor is further configured to cause the device to:
receive, from the network entity, a capabilities request transmission; and
transmit a capabilities response transmission responsive to the capabilities request transmission and indicating UE assistance capabilities of the device.

7. The device of claim 1, wherein the request for UE assistance includes an indication of a UE assistance request and information regarding a corresponding requested adaptation for the UE assistance request.

8. The device of claim 1, wherein the network entity is operating in network energy saving mode, and wherein the device is configured with a first set of Random Access Channel (RACH) resources and a second set of RACH resources, wherein the first set of RACH resources correspond to legacy RACH resources, and wherein the second set of RACH resources correspond to network energy savings (NES) RACH resources.

9. The device of claim 8, wherein the at least one processor is further configured to cause the device to:
receive a system information block (SIB) message; and
determine that the network entity has deactivated the second set of RACH resources based on the SIB message.

10. The device of claim 8, wherein the first set of RACH resources include one or more of preamble IDs, RACH occasions, PRACH configurations, or RACH beams.

11. The device of claim 1, wherein the at least one processor is further configured to cause the device to:
perform UE discovery operations;
establish a communication link with the UE; and
exchange UE collaboration information with the UE.

12. The device of claim 11, wherein the at least one processor is further configured to cause the device to:
determine whether one or more UE collaboration conditions for providing UE assistance to the UE are satisfied; and
transmit an indication or capability for UE collaboration or assistance to the UE, the network entity, or both, based on a determination that the one or more UE conditions are satisfied.

13. The device of claim 12, wherein the at least one processor configured to cause the device to determine whether one or more UE assistance conditions are satisfied includes to:
determine whether the one or more UE assistance conditions are satisfied based on UE collaboration information, wherein the UE collaboration information includes transmission latency information, serving cell information, radio resource control (RRC) status information, battery power information, energy cost information, or a combination thereof, for the device.

14. The device of claim 1, wherein the device is connected to the UE via a sidelink connection or via a local wireless connection.

15. The device of claim 1, wherein the at least one processor is configured to receive the UE assistance information from the UE includes to:
receive the UE assistance information as application data from the network entity or from a second network entity.

16. The device of claim 1, wherein the at least one processor is further configured to cause the device to:
receive second UE assistance information from a second UE, wherein the UE and the second UE correspond to a group of UEs; and
transmit, to the network entity, a second request for UE assistance based on the received second UE assistance information from the second UE, wherein the second request is transmitted in a same transmission as the request for UE assistance for the UE or in a different transmission.

17. The device of claim 1, wherein the UE assistance information from the UE indicates assistance for the network entity, and wherein the device is connected to the network entity during receipt of the UE assistance information.

18. The device of claim 1, wherein the UE assistance information from the UE indicates assistance for a second network entity, wherein the device is connected to the network entity and not connected to the second network entity, and wherein the at least one processor is further configured to:
transmit an indication of the second network entity to the network entity.

19. The device of claim 1, wherein the at least one processor is further configured to cause the device to:
receive second UE assistance information from a second UE;
transmit, to the network entity, a second request for UE assistance based on the received second UE assistance information from the second UE;
receive second UE assistance response information from the network entity responsive to the transmission of the second request for UE assistance and indicating a negative indication for UE assistance for the second UE; and
transmit the negative indication to the second UE.

20. The device of claim 1, wherein the at least one processor is further configured to cause the device to:
receive a system information block (SIB) message with updated Random Access Channel (RACH) information, and wherein the updated RACH information:
corresponds to a RACH configuration with one or more changed parameters or activation of a dedicated set of RACH resources; or
includes a set of RACH preamble IDs, a RACH power configuration, a RACH timing adjustment, an activated RACH window, an activated RACH resource, or a combination thereof.
